(19) United States
(12) Patent Application Publication
(10) Pub. No.: US 2020/0387018 A1
(43) Pub. Date: Dec. 10, 2020

(54) LIQUID CRYSTAL DISPLAY PANEL, FABRICATION METHOD THEREFOR AND DISPLAY DEVICE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventor: Peng WU, Beijing (CN)

(73) Assignees: Hefei Xinsheng Optoelectronics Technology Co., Ltd., Hefei, Anhui (CN); BOE Technology Group Co., Ltd., Beijing (CN)

(21) Appl. No.: 16/641,681

(22) PCT Filed: Mar. 19, 2019
(86) PCT No.: PCT/CN2019/078785

§ 371 Date: Feb. 25, 2020

(30) Foreign Application Priority Data
Mar. 26, 2018 (CN) 201810252234.3

(51) Int. Cl. G02F 1/1339; G02F 1/1335

(52) U.S. Cl. CPC G02F 1/1339; G02F 1/133514; G02F 2202/28; G02F 2201/50; G02F 1/133512

(57) ABSTRACT

A liquid crystal display panel, a fabrication method therefor and a display device, wherein by means of providing a plurality of concave-convex structures in a region, corresponding to frame sealing glue, of at least one film layer in a passivation layer and a planarization layer, the area of contact between the frame sealing glue and the planarization layer and/or the passivation layer may be increased, the adhesion between the frame sealing glue and the planarization layer and/or the passivation layer may be enhanced, and the concave-convex structures may effectively prevent external moisture from entering into a liquid crystal box, thus improving the moisture-resistant capabilities of the liquid display panel.

This application is a US National Stage of International Application No. PCT/CN2019/078785, filed Mar. 19, 2019, which claims priority to a Chinese Patent Application No. 201810252234.3 filed with the Chinese Patent Office on 26 Mar. 2018 with the title of “Liquid Crystal Display Panel, Fabrication Method Thereof and Display Device”, which is hereby incorporated by reference in its entirety.

### FIELD

The disclosure relates to the technical field of display, and particularly to a liquid crystal display panel, a fabrication method thereof and a display device.

### BACKGROUND

Due to the characteristics such as small size, low power consumption and no radiation, a liquid crystal display (LCD) has held a dominant position in the current flat panel display market. In order to improve the market competitiveness, the current LCD is gradually developing towards a narrow bezel so as to ensure that the user experience is better during large-screen display and multi-screen tiled display. Meanwhile, due to the popularization of the LCD, the working environment thereof is enabled to be wider and wider, and the requirement for environmental resistance such as waterproof ability is also higher and higher.

### SUMMARY

Embodiments of the disclosure provide a liquid crystal display panel, a fabrication method thereof and a display device, and specific solutions are as follows.

An embodiment of the disclosure provides a liquid crystal display panel, which includes an array substrate and a color filter substrate opposite to each other; and a sealant between the array substrate and the color filter substrate, wherein a contact surface of at least one of the array substrate and the color filter substrate in contact with the sealant is provided with a concave-convex structure.

Accordingly, an embodiment of the disclosure further provides a display device including the above any liquid crystal display panel provided by the embodiment of the disclosure.

Accordingly, an embodiment of the disclosure further provides a fabrication method of the liquid crystal display panel, which includes: forming an array substrate and a color filter substrate, wherein a concave-convex structure is formed in a region of at least one of the substrates corresponding to the sealant to be formed when the array substrate and the color filter substrate are formed; and forming the sealant between the array substrate and the color filter substrate.

The embodiments of the disclosure have the beneficial effects as follows.

In the liquid crystal display panel, the fabrication method thereof and the display device according to the embodiments of the disclosure, a concave-convex structure is arranged on a contact surface of at least one of the array substrate and the color filter substrate in contact with the sealant, the contact area between the sealant and each substrate may be increased, the adhesion between the sealant and each substrate may be enhanced, and the concave-convex structure may effectively prevent external moisture from entering a liquid crystal cell, thus improving the moisture resistance of the liquid crystal display panel.

### BRIEF DESCRIPTION OF THE DRAWINGS

FIG. 1 is a schematic structural diagram of a liquid crystal display panel in the related art;

FIG. 2 is a first schematic structural diagram of a liquid crystal display panel in accordance with an embodiment of the disclosure;

FIG. 3 is a second schematic structural diagram of a liquid crystal display panel in accordance with an embodiment of the disclosure;

FIG. 4 is a third schematic structural diagram of a liquid crystal display panel in accordance with an embodiment of the disclosure;

FIG. 5 is a fourth schematic structural diagram of a liquid crystal display panel in accordance with an embodiment of the disclosure;

FIG. 6 is a fifth schematic structural diagram of a liquid crystal display panel in accordance with an embodiment of the disclosure;

FIG. 7 is a sixth schematic structural diagram of a liquid crystal display panel in accordance with an embodiment of the disclosure;

FIG. 8 is a flow diagram of a fabrication method of a liquid crystal display panel in accordance with an embodiment of the disclosure;

FIG. 9a to FIG. 9c are respectively schematic diagrams of sectional structures after each step is performed when an array substrate is fabricated in an embodiment of the disclosure; and

FIG. 10a to FIG. 10c are respectively schematic diagrams of sectional structures after each step is performed when a color filter substrate is fabricated in an embodiment of the disclosure.

### DETAILED DESCRIPTION

A display panel in an LCD is generally formed by assembling, in cell alignment, an array substrate and a liquid crystal display panel fabricated, and the sealant is arranged between the array substrate and the liquid crystal display panel to guarantee the sealing property of the array substrate and the liquid crystal display panel. The display panel may be divided into a display region and a peripheral region around the display region, and the sealant is located in the peripheral region of the display panel. With the development of a narrow bezel liquid crystal display technology, the peripheral region of the display panel is narrower and narrower, and thus, the width of the sealant located in the peripheral region of the display panel is also smaller and smaller, but the adhesion strength between the array substrate and the liquid crystal display panel may be lowered due to the oversmall width of the sealant.

To make the objects, technical solutions and advantages of the disclosure clearer, implementations of a liquid crystal display panel, a fabrication method thereof and a display device according to embodiments of the disclosure are described in detail below in combination with accompanying drawings.

The thickness and shape of each layer of film in the accompanying drawings are only intended to schematically describe the content of the disclosure, rather than to reflect the true proportion of the liquid crystal display panel.

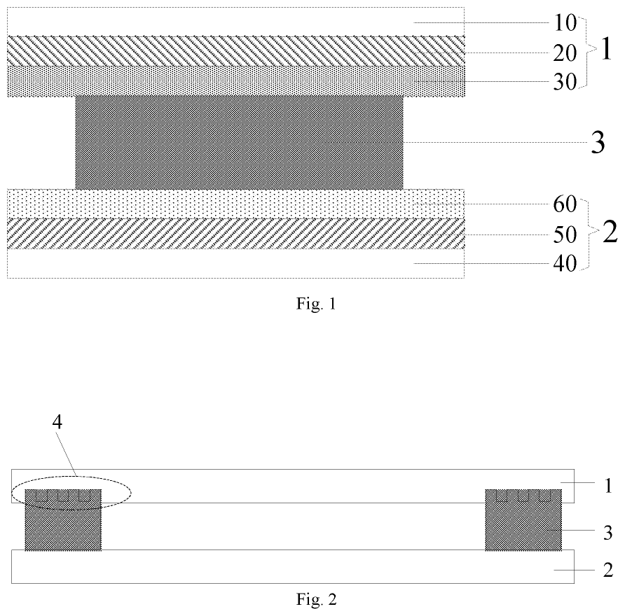

A liquid crystal display panel in the related art, as shown in FIG. 1, includes an array substrate 1 and a color filter substrate 2 arranged opposite to each other, and the sealant 3 located between the array substrate 1 and the color filter substrate 2. The array substrate 1 includes a first base substrate 10, a gate insulation layer 20 located at one side of the first base substrate 10 facing the color filter substrate 2, and a passivation layer 30 located at one side of the gate insulation layer 20 facing the color filter substrate 2; and the color filter substrate 2 includes a second base substrate 40, a black matrix layer 50 located at one side of the second base substrate 40 facing the array substrate 1, and a planarization layer 60 located at one side of the black matrix layer 50 facing the array substrate 1. With the development of the narrow bezel liquid crystal display technology, the peripheral region of the display panel is narrower and narrower, and thus, the width of the sealant 3 located in the peripheral region of the display panel is also smaller and smaller, but the adhesion strength between the array substrate and the liquid crystal display panel may be lowered due to the oversmall width of the sealant 3.

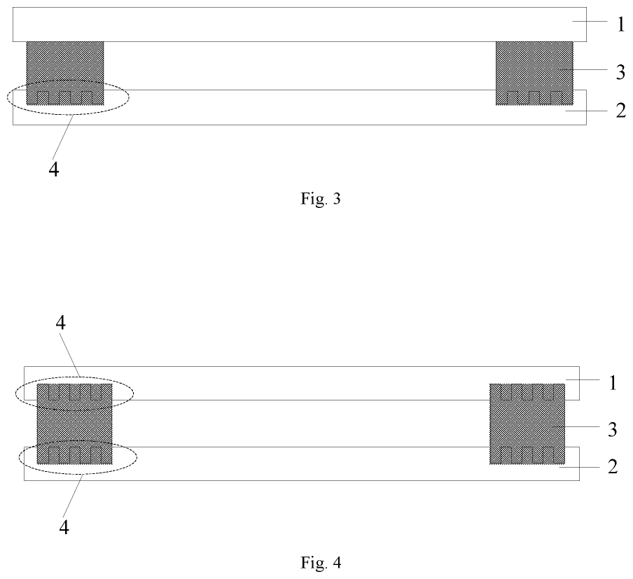

For this purpose, an embodiment of the disclosure provides a liquid crystal display panel, as shown in FIG. 2 to FIG. 4. The liquid crystal display panel includes an array substrate 1 and a color filter substrate 2 arranged opposite to each other, and a sealant 3 located between the array substrate 1 and the color filter substrate 2. A contact surface of at least one of the array substrate 1 and the color filter substrate 2 in contact with the sealant 3 is provided with a concave-convex structure 4. Specifically, as shown in FIG. 2, a contact surface of the array substrate 1 in contact with the sealant 3 is provided with the concave-convex structure 4; or as shown in FIG. 3, a contact surface of the color filter substrate 2 in contact with the sealant 3 is provided with the concave-convex structure 4; or as shown in FIG. 4, a contact surface of the array substrate 1 in contact with the sealant 3 is provided with the concave-convex structure 4, and a contact surface of the color filter substrate 2 in contact with the sealant 3 is also provided with the concave-convex structure 4.

In the liquid crystal display panel according to the embodiment of the disclosure, the concave-convex structure is arranged on the contact surface of at least one of the array substrate and the color filter substrate in contact with the sealant, the contact area between the sealant and the substrate may be increased, the adhesion between the sealant and the substrate may be enhanced, and the concave-convex structure may effectively prevent external moisture from entering a liquid crystal cell, thus improving the moisture resistance of the liquid crystal display panel.

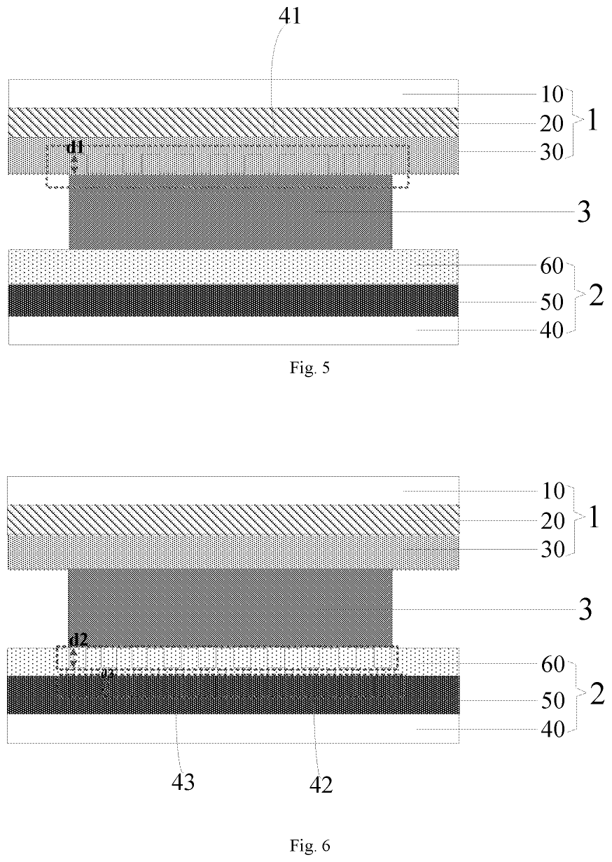

Optionally, in the liquid crystal display panel according to the embodiment of the disclosure, as shown in FIG. 5 to FIG. 7, the array substrate 1 includes a first base substrate 10 and a passivation layer 30 located at one side of the first base substrate 10 facing the color filter substrate 2; and the concave-convex structure includes a first concave-convex structure 41, and the first concave-convex structure 41 is located on a contact surface of the passivation layer 30 in contact with the sealant 3.

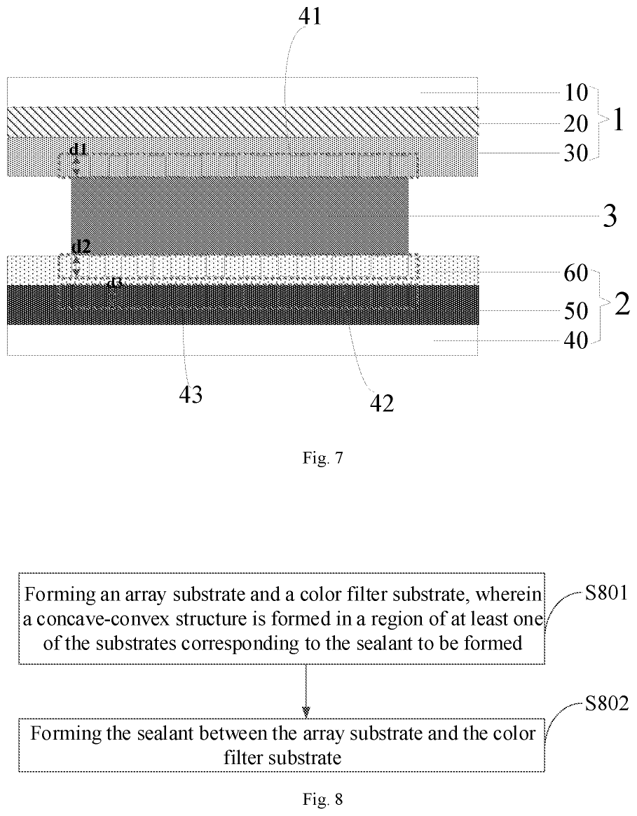

Optionally, in the liquid crystal display panel according to the embodiment of the disclosure, the first concave-convex structure may be formed by forming grooves in a region of the passivation layer corresponding to the sealant. As shown in FIG. 5 and FIG. 7, in the region of the passivation layer 30 corresponding to the sealant 3, the depth d1 of a concave part of the passivation layer 30 is smaller than the thickness of the passivation layer 30, that is, the concave part of the passivation layer 30 does not penetrate through the passivation layer 30, which can avoid affecting other film layers between the passivation layer 30 and the first base substrate 10 when subsequent film layers are fabricated.

Optionally, in the liquid crystal display panel according to the embodiment of the disclosure, as shown in FIG. 6 and FIG. 7, the color filter substrate 2 includes a second base substrate 40 and a planarization layer 60 located at one side of the second base substrate 40 facing the array substrate 1; and the concave-convex structure includes a second concave-convex structure 42 located on a contact surface of the planarization layer 60 in contact with the sealant 3.

Optionally, in the liquid crystal display panel according to the embodiment of the disclosure, the second concave-convex structure may be formed by forming grooves in a region, of the planarization layer corresponding to the sealant. As shown in FIG. 6 and FIG. 7, in the region of the planarization layer 60 corresponding to the sealant 3, the depth d2 of a concave part of the planarization layer 60 is smaller than the thickness of the planarization layer 60, that is, the concave part of the planarization layer 60 does not penetrate through the planarization layer 60, which can avoid affecting other film layers between the planarization layer 60 and the second substrate 40 when subsequent film layers are fabricated.

In the liquid crystal display panel according to the embodiment of the disclosure, the concave-convex structure is arranged in the region of at least one of the passivation layer and the planarization layer corresponding to the sealant, thus the contact area between the sealant and the planarization layer and/or the passivation layer may be increased, the adhesion between the sealant and the planarization layer and/or the passivation layer may be enhanced, and the concave-convex structure may effectively prevent external moisture from entering a liquid crystal cell, thus improving the moisture resistance of the liquid crystal display panel.

Optionally, in the above liquid crystal display panel according to the embodiment of the disclosure, as shown in FIG. 5 to FIG. 7, the depth d1 of the concave part of the passivation layer 30 is equal to the depth d2 of the concave part of the planarization layer 60. In this way, a fabrication process may be unified, and a fabrication flow may be simplified.

Optionally, in the above liquid crystal display panel according to the embodiment of the disclosure, as shown in FIG. 7, the color filter substrate 2 further includes a black matrix layer 50 located between the second base substrate 40 and the planarization layer 60, and a contact surface of the black matrix layer 50 in contact with the planarization layer 60 is provided with a third concave-convex structure 43 corresponding to the second concave-convex structure 42 in a region corresponding to the sealant 3; and the thickness of the planarization layer 60 is uniform in the region corresponding to the sealant 3.

In the disclosure, firstly a plurality of grooves are etched in a region of the black matrix layer 50 corresponding to the sealant 3, in a photolithography process, to form the third concave-convex structure 43, and then the planarization layer 60 is coated on the black matrix layer 50, that the material of the planarization layer 60 may cover the surface of the black matrix layer 50, so that the planarization layer 60 is provided with the second concave-convex structure 42. The planarization layer 60 is transparent not to be beneficial to processes such as exposure, and therefore, the third concave-convex structure 43 is firstly fabricated on the black matrix layer 50 in the disclosure.

Optionally, in the above liquid crystal display panel according to the embodiment of the disclosure, as shown in FIG. 6 and FIG. 7, in the region of the black matrix layer 50 corresponding to the sealant 3, the depth d3 of a concave part of the black matrix layer 50 is smaller than the thickness of the black matrix layer 50. Since the black matrix layer 50 has a shading effect, if the concave part of the black matrix layer 50 penetrates through the black matrix layer 50, the penetrated concave part may allow light to be transmitted, and light may appear during black picture display, thus affecting the display effect of the display panel.

Optionally, in the above liquid crystal display panel according to the embodiment of the disclosure, as shown in FIG. 4 and FIG. 7, the concave-convex structure includes a first concave-convex structure 41 and a second concave-convex structure 42.

The first concave-convex structure 41 is located on the contact surface of the array substrate 1 in contact with the sealant 3, and the second concave-convex structure 42 is located on the contact surface of the color filter substrate 2 in contact with the sealant 3; and the position of concave part of the first concave-convex structure 41 is opposite to that of the second concave-convex structure 42.

Optionally, in the above liquid crystal display panel according to the embodiment of the disclosure, the orthographic projection of the concave part of the first concave-convex structure on the color filter substrate is superposed with the concave part of the second concave-convex structure.

That is, the first concave-convex structure 41 and the second concave-convex structure 42 are symmetrically arranged, which is beneficial to the unification of the fabrication process and simplification of the fabrication flow.

Optionally, in the above liquid crystal display panel according to the embodiment of the disclosure, as shown in FIG. 7, when the first concave-convex structure 41 and the second concave-convex structure 42 are simultaneously provided, the concave part of the passivation layer 30 is opposite to the concave part of the planarization layer 60. That is, the first concave-convex structure 41 and the second concave-convex structure 42 are symmetrically arranged, which is beneficial to the unification of the fabrication process and simplification of the fabrication flow.

Optionally, in the above liquid crystal display panel according to the embodiment of the disclosure, as shown in FIG. 7, the area of an orthographic projection of the concave part of the passivation layer 30 on the first base substrate 10 is equal to that of an orthographic projection of the concave part of the planarization layer 60 on the second base substrate 40. In this way, the fabrication process may be further unified, and the fabrication flow may be simplified.

During specific implementation, the number and widths of the concave parts in the concave-convex structure according to the embodiment of the disclosure may be adjusted according to parameters of product so as to select the optimal conditions, there are no limits herein.

It should be noted that, in the above liquid crystal display panel according to the embodiment of the disclosure, an example in which a film layer of the array substrate in contact with the sealant is the passivation layer is described, and the example is also applicable to liquid crystal display panels in which film layers of array substrates in contact with the sealant are any other film layers, the descriptions thereof are omitted herein. Similarly, an example in which a film layer of the color filter substrate in contact with the sealant is the planarization layer is described, and the example is also applicable to liquid crystal display panels in which film layers, of color filter substrates in contact with the sealant are any other film layers, the descriptions thereof are omitted herein.

In addition, it should be noted that, in the above liquid crystal display panel according to the embodiment of the disclosure, the array substrate is further provided with other essential film layers for realizing liquid crystal display in addition to the above passivation layer, and the color filter substrate is further provided with other essential film layers for realizing liquid crystal display in addition to the above black matrix layer and planarization layer, the descriptions thereof are omitted herein.

Based on the same inventive concept, an embodiment of the disclosure further provides a fabrication method of any one above liquid crystal display panel according to the embodiment of the disclosure. As shown in FIG. 8, the method includes the following steps.

S801 is to form an array substrate and a color filter substrate, wherein when forming the array substrate and the color filter substrate, the concave-convex structure is formed in a region of at least one of the substrates corresponding to the sealant to be formed.

S802 is to form the sealant between the array substrate and the color filter substrate.

In the fabrication method of the liquid crystal display panel according to the embodiment of the disclosure, the concave-convex structure is arranged on a contact surface of at least one of the array substrate and the color filter substrate in contact with the sealant, the contact area between the sealant and the array substrate and/or the color filter substrate may be increased, the adhesion between the sealant and the array substrate and/or the color filter substrate may be enhanced, and the concave-convex structure may effectively prevent external moisture from entering a liquid crystal cell, thus improving the moisture resistance of the liquid crystal display panel.

During specific implementation, in the above fabrication method of the liquid crystal display panel according to the embodiment of the disclosure, the formation order of the array substrate and the color filter substrate is not limited, the color filter substrate may be formed after the array substrate is formed, or the array substrate may be formed after the color filter substrate is formed.

Optionally, in the above fabrication method of the liquid crystal display panel according to the embodiment of the disclosure, the step of forming the concave-convex structure in a region of the array substrate corresponding to the sealant to be formed specifically includes: forming a pattern of a passivation layer on a first base substrate, wherein the passivation layer is provided with first concave-convex structure in a region corresponding to the sealant.

Optionally, in the above fabrication method of the liquid crystal display panel according to the embodiment of the disclosure, the step of forming the concave-convex structure in a region of the color filter substrate corresponding to the t sealant to be formed includes: forming a pattern of a black matrix layer on a second base substrate, wherein the black matrix layer is provided with a third concave-convex structure in a region corresponding to the sealant; and coating a planarization layer on the black matrix layer, wherein the planarization layer is provided with a second concave-convex structure corresponding to the third concave-convex structure in a region corresponding to the sealant, and the thickness of the planarization layer is uniform in the region corresponding to the sealant.

Optionally, in the above fabrication method of the liquid crystal display panel according to the embodiment of the disclosure, the third concave-convex structure is formed in the region of the black matrix layer corresponding to the sealant in one pattern process. In this way, when the liquid crystal display panel is fabricated, a pattern of the third concave-convex structure is formed together with the pattern of the black matrix layer in one pattern process, there is no need to add a process of fabricating the third concave-convex structure alone, so that the fabrication process may be simplified, the production cost may be reduced, and the production efficiency may be increased.

Optionally, in the above liquid crystal display panel according to the embodiment of the disclosure, the base substrate may be a glass substrate, there are no limits herein.

It should be noted that, in the above fabrication method according to the embodiment of the disclosure, the pattern process may only include a photolithography process, or may include the photolithography process and an etching process and may also include other processes such as printing and inkjet for forming predetermined pattern; and the photolithography process means a process including technical flows such as film formation, exposure and development and forming patterns by photoresist, a mask, an exposure machine, etc.

The fabrication method of the liquid crystal display panel is described below by taking the liquid crystal display panel as shown in FIG. 7 as an example. The fabrication method of the liquid crystal display panel may include the following steps.

An array substrate 1 is fabricated as follows.

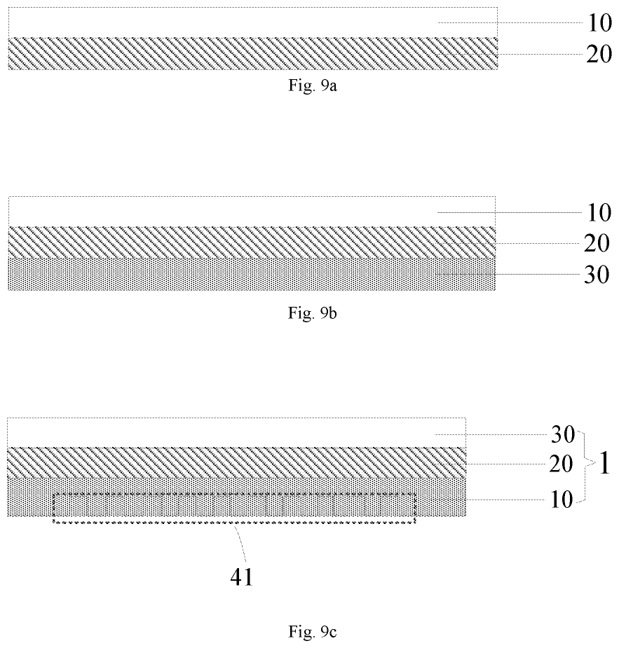

(1) A gate insulation layer 20 is formed on a first base substrate 10 in one pattern process, as shown in FIG. 9a.

(2) A passivation layer 30 is formed on the first base substrate 10 with the gate insulation layer 20 in one pattern process, as shown in FIG. 9b.

(3) A pattern of a first concave-convex structure 41 is formed in a region of the passivation layer 30 corresponding to the sealant to be formed in one pattern process, wherein the depth of a concave part of the passivation layer 30 is smaller than the thickness of the passivation layer 30, as shown in FIG. 9c; and thus it can avoid affecting other film layers between the passivation layer 30 and the first base substrate 10 when subsequent film layers are fabricated.

The array substrate 1 of the liquid crystal display panel according to the embodiment of the disclosure is formed via the above steps (1)-(3).

A color filter substrate 2 is fabricated as follows.

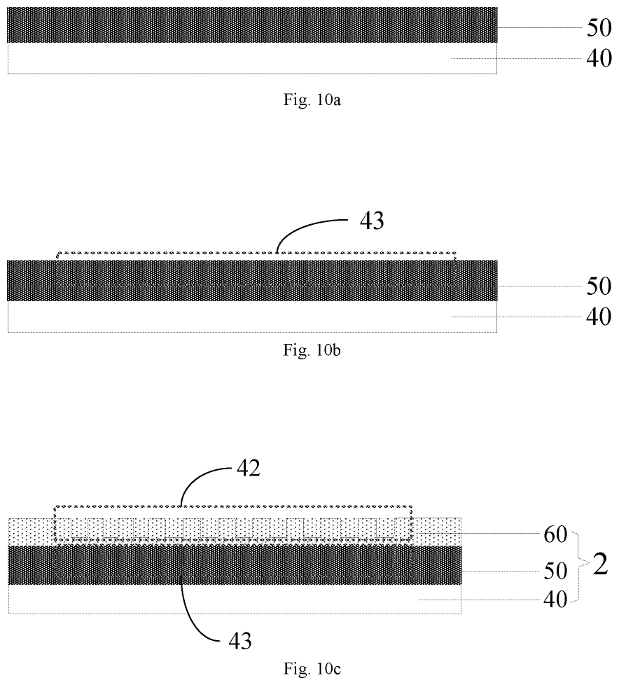

(1′) A pattern of a black matrix layer 50 is formed on a second base substrate 40 in one pattern process, as shown in FIG. 10a.

(2′) A pattern of a third concave-convex structure 43 is formed in a region of the black matrix layer 50 corresponding to the sealant to be formed in one pattern process, wherein the depth of a concave part of the black matrix layer 50 is smaller than the thickness of the black matrix layer 50, as shown in FIG. 10b.

Since the black matrix layer 50 has a shading effect, if the concave part of the black matrix layer 50 penetrates through the black matrix layer 50, the penetrated concave part may allow light to be transmitted, and light may appear during black picture display, thus affecting the display effect of the display panel.

(3′) A planarization layer 60 is coated on a second base substrate 40 formed with the black matrix layer 50 with a third concave-convex structure 43, wherein the planarization layer 60 is provided with a second concave-convex structure 42 corresponding to the third concave-convex structure 43 in a region corresponding to the sealant, and the thickness of the planarization layer 60 is uniform in the region corresponding to the sealant, as shown in FIG. 10c. The color filter substrate 2 of the liquid crystal display panel according to the embodiment of the disclosure is formed via the above steps (1′)-(3′).

The liquid crystal display panel as shown in FIG. 7 is formed by applying the sealant 3 between the array substrate 1 and the color filter substrate 2 formed above. In this display panel, the concave-convex structure is provided in regions of the passivation layer and the planarization layer corresponding to the sealant, so that the contact area between the sealant and the planarization layer and/or the passivation layer may be increased, the adhesion between the sealant and the planarization layer and/or the passivation layer may be enhanced, and the concave-convex structure may effectively prevent external moisture from entering a liquid crystal cell, thus improving the moisture resistance of the liquid crystal display panel.

In the fabrication method of the liquid crystal display panel according to the embodiment of the disclosure, the concave-convex structure is arranged in the regions of both the passivation layer and the planarization layer corresponding to the sealant. During specific implementation, the first concave-convex structure may be only arranged in the region of the passivation layer corresponding to the sealant, or the second concave-convex structure may be only arranged in the region of the planarization layer corresponding to the sealant, which is selected specifically according to an actual demand.

Optionally, the liquid crystal display panel provided by the embodiment of the disclosure further includes other functional film layers which adopt a technology same as the related art, the descriptions thereof are omitted herein.

Based on the same inventive concept, an embodiment of the disclosure further provides a display device including the above liquid crystal display panel provided by the embodiment of the disclosure. The display device may be a mobile phone, a tablet personal computer, a television, a display, a notebook computer, a digital photo frame, a navigator or any product or component with a display function. Other essential components of the display device should be regarded to be provided by those skilled in the art so as not to be described herein and not to be constructed as a limitation on the disclosure. The implementation of the display device may refer to the embodiment of the above liquid crystal display panel, the descriptions thereof are omitted herein.

In the liquid crystal display panel, the fabrication method thereof and the display device according to the embodiments of the disclosure, the concave-convex structure is arranged on the contact surface of at least one of the array substrate and the color filter substrate in contact with the sealant, the contact area between the sealant and each substrate may be increased, the adhesion between the sealant and each substrate may be enhanced, and the concave-convex structure may effectively prevent external moisture from entering a liquid crystal cell, thus improving the moisture resistance of the liquid crystal display panel.

Evidently those skilled in the art can make various modifications and variations to the invention without departing from the spirit and scope of the invention. Thus the invention is also intended to encompass these modifications and variations therein as long as these modifications and variations come into the scope of the claims of the invention and their equivalents.

1. A liquid crystal display panel, comprising:
an array substrate and a color filter substrate opposite to each other; and
a sealant between the array substrate and the color filter substrate;
wherein a contact surface of at least one of the array substrate and the color filter substrate in contact with the sealant is provided with a concave-convex structure.

2. The liquid crystal display panel according to claim 1, wherein the array substrate comprises a first base substrate and a passivation layer at one side of the first base substrate facing the color filter substrate; and
the concave-convex structure comprises a first concave-convex structure on a contact surface of the passivation layer in contact with the sealant.

3. The liquid crystal display panel according to claim 1, wherein the color filter substrate comprises a second base substrate and a planarization layer at one side of the second base substrate facing the array substrate; and
the concave-convex structure comprises a second concave-convex structure on a contact surface of the planarization layer in contact with the sealant.

4. The liquid crystal display panel according to claim 3, wherein the color filter substrate further comprises a black matrix layer between the second base substrate and the planarization layer;
a contact surface of the black matrix layer in contact with the planarization layer is provided with a third concave-convex structure corresponding to the second concave-convex structure in a region corresponding to the sealant; and
a thickness of the planarization layer is uniform in the region corresponding to the sealant.

5. The liquid crystal display panel according to claim 1, wherein the concave-convex structure comprises a first concave-convex structure and a second concave-convex structure;
the first concave-convex structure is on the contact surface of the array substrate in contact with the sealant, and the second concave-convex structure is on the contact surface of the color filter substrate in contact with the sealant; and
a position of a concave part of the first concave-convex structure is opposite to a position of a concave part of the second concave-convex structure.

6. The liquid crystal display panel according to claim 5, wherein an orthographic projection of the concave part of the first concave-convex structure on the color filter substrate is superposed with the concave part of the second concave-convex structure.

7. A display device, comprising the liquid crystal display panel according to claim 1.

8. A fabrication method of a liquid crystal display panel, comprising:
forming an array substrate and a color filter substrate, wherein a concave-convex structure is formed in a region of at least one of the substrates corresponding to a sealant to be formed when the array substrate and the color filter substrate are formed; and
forming the sealant between the array substrate and the color filter substrate.

9. The fabrication method according to claim 8, wherein forming the concave-convex structure in the region of the array substrate corresponding the sealant to be formed comprises:
forming a pattern of a passivation layer on a first base substrate, wherein the passivation layer is provided with a first concave-convex structure in a region corresponding to the sealant.

10. The fabrication method according to claim 8, wherein forming the concave-convex structure in the region of the color filter substrate corresponding to the sealant to be formed comprises:
forming a pattern of a black matrix layer on a second base substrate, wherein the black matrix layer is provided with a third concave-convex structure in a region corresponding to the sealant; and
coating a planarization layer on the black matrix layer, wherein the planarization layer is provided with a second concave-convex structure corresponding to the third concave-convex structure in a region corresponding to the sealant, and a thickness of the planarization layer is uniform in the region corresponding to the sealant.
